(19) United States
(12) Patent Application Publication
(10) Pub. No.: US 2008/0141129 A1
(43) Pub. Date: Jun. 12, 2008

(54) Operation apparatus for on-vehicle device

(75) Inventors: Yoshiki Oozawa, Chita-gun (JP); Toshikazu Yokota, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/000,305

(22) Filed: Dec. 11, 2007

(30) Foreign Application Priority Data
Dec. 12, 2006 (JP) 2006-334417

(51) Int. Cl. G06F 3/048

(52) U.S. Cl. 715/702

(57) ABSTRACT

An operation apparatus for an on-vehicle device mounted on a vehicle includes a display device, a touch sensitive panel, a hard key, and a control device. The display device is configured to display a selection picture, in which a plurality of selection items are arranged. The touch sensitive panel is disposed on a screen of the display device. The control device is configured to scroll the plurality of selection items in the selection picture in accordance with a user operation. The control device scrolls the plurality of selection items in the selection picture by a first amount when the user operation is a touch operation by a user to the touch sensitive panel. The control device scrolls the plurality of selection items in the selection picture by a second amount when the user operation is a switch operation by the user to the hard key.

### CROSS REFERENCE TO RELATED APPLICATION

This application is based on and incorporates herein by reference Japanese Patent Application No. 2006-334417 filed on Dec. 12, 2006.

### BACKGROUND OF THE INVENTION

1. Field of the Invention

The present invention relates to an operation apparatus for an on-vehicle device used for various instructions and settings of the on-vehicle device.

2. Description of Related Art

For example, in a vehicle navigation apparatus, a display device having a liquid crystal display that is mounted in a vehicle cabin (a center in the instrument panel) displays a present traveling position of the vehicle, a map of a surrounding, and various input setting pictures (selection pictures). A touch sensitive panel (touch sensitive screen) is provided on the screen of the display device, and a user directly touches portions in the touch sensitive panel corresponding to various selection items (icons, character key) indicated on the selection picture. In this way, the user performs various selections, settings, input instructions, such as search and setting of a destination, change of a scale factor for displaying the map.

Also, another vehicle navigation apparatus includes an operation panel that has multiple hard keys (mechanical switches) as input operation means in addition to the touch sensitive panel (for example, see JP-A-2006-85458). The operation panel includes multiple push button switches or rotary switches as the hard keys, and is provided in a lower side of the display device (e.g., below a console). The operation of the push button switches or the rotary switches of the operation panel achieves equivalent functions to the touch operation of the touch sensitive panel.

However, in the above vehicle navigation apparatus, multiple hard keys are provided in the operation panel as an alternative of a touch sensitive panel for selecting selection item. In this case, the multiple hard keys simply have operational functions equivalent to the operation of the touch sensitive panel. As a result, even through two sets of input operation means (i.e., the touch sensitive panel and the hard keys) are provided, characteristic (advantage) of operability of each of the input operation means is not considered. Therefore, the above configuration does not necessarily improve the operability for the user.

Note that, in the above case, because each of the touch sensitive panel and the hard key merely has the operational function equivalent to each other, the number of selection items in the selection picture may be uselessly increased, or layout of the selection items may become more limited. Thus, the viewability of the selection picture (and operability of the selection picture) have something to be improved.

### SUMMARY OF THE INVENTION

The present invention is made in view of the above disadvantages. Thus, it is an objective of the present invention to address at least one of the above disadvantages.

To achieve the objective of the present invention, there is provided an operation apparatus for an on-vehicle device mounted on a vehicle, wherein the apparatus is used for performing various instructions and settings of the on-vehicle device, and the apparatus includes a display device, a touch sensitive panel, a hard key, and a control device. The display device is configured to display a selection picture, in which a plurality of selection items are arranged. The touch sensitive panel is disposed on a screen of the display device, and enables one of the plurality of selection items in the selection picture to be selected by a touch operation of a user. The hard key enables one of the plurality of selection items in the selection picture to be selected by a switch operation of the user. The control device is configured to scroll the plurality of selection items in the selection picture in accordance with a user operation. The control device scrolls the plurality of selection items in the selection picture by a first amount when the user operation is the touch operation by the user to the touch sensitive panel. The control device scrolls the plurality of selection items in the selection picture by a second amount when the user operation is the switch operation by the user to the hard key. The first amount is different from the second amount.

To achieve the objective of the present invention, there is also provided an operation apparatus for controlling a picture in a screen of a display device, the apparatus including a touch sensitive panel, a hard key, and a control device. The touch sensitive panel is configured to output a first signal when the touch sensitive panel is touched. The hard key is configured to output a second signal when the hard key is operated. The control device is configured to scroll the picture in the screen upon receiving one of the first and second signals. The control device scrolls the picture by a first amount when the control device receives the first signal. The control device scrolls the picture by a second amount when the control device receives the second signal. The second amount is different from the first amount.

### BRIEF DESCRIPTION OF THE DRAWINGS

The invention, together with additional objectives, features and advantages thereof, will be best understood from the following description, the appended claims and the accompanying drawings in which:

FIG. 1 is a block diagram schematically showing an electric configuration of a navigation system according to one embodiment of the present invention;

FIG. 2 is a diagram showing an example of a list display picture; and

FIG. 3 is a diagram showing an example of a map scale setting picture.

### DETAILED DESCRIPTION OF PREFERRED EMBODIMENTS

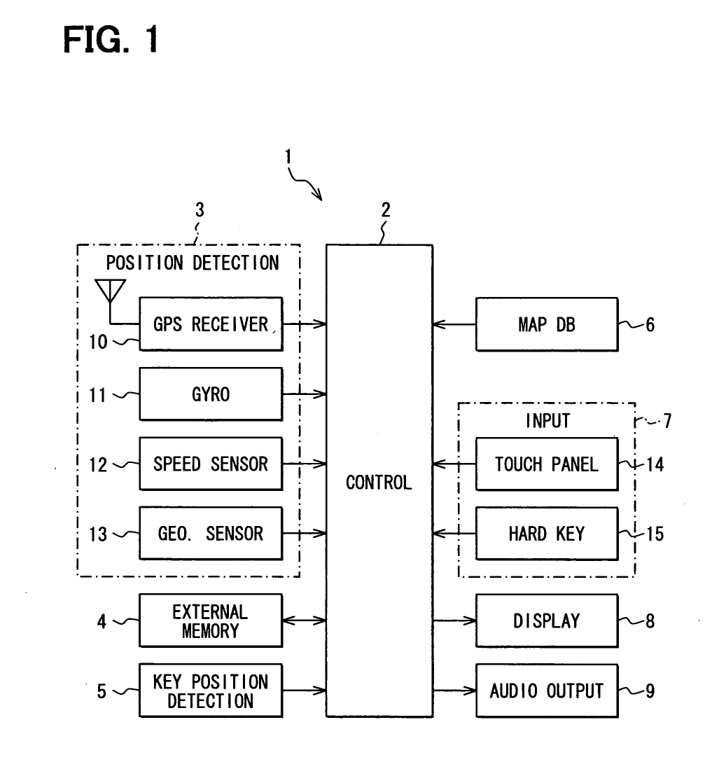

One embodiment, in which the present invention is applied to an operation apparatus for a navigation system, is described with reference to accompanying drawings. FIG. 1 schematically shows an electric configuration of a navigation system 1 that serves as an on-vehicle device according to the present embodiment.

The navigation system 1 mainly includes a microcomputer that has a CPU, a ROM, a RAM, an I/O (all not shown), and includes a control circuit 2 for a total control. The control circuit 2 is connected with a position detector 3, an external memory 4, a key position detector 5, a map database 6, an input operation portion 7, a display device 8, and an audio output device 9. The position detector 3 detects a present position of a vehicle. The external memory 4 stores various programs and various data sets including display data. The key position detector 5 detects a position of an ignition key of the vehicle. The audio output device 9 performs audio guidance.

The position detector 3 includes a GPS receiver 10, a gyroscope 11, a speed sensor 12, and a geomagnetic sensor 13, as well known. The control circuit 2 highly accurately detects the present position (absolute position), a travel direction, a speed, and a travel distance of the own vehicle based on signals sent from the various sensors 10 to 13.

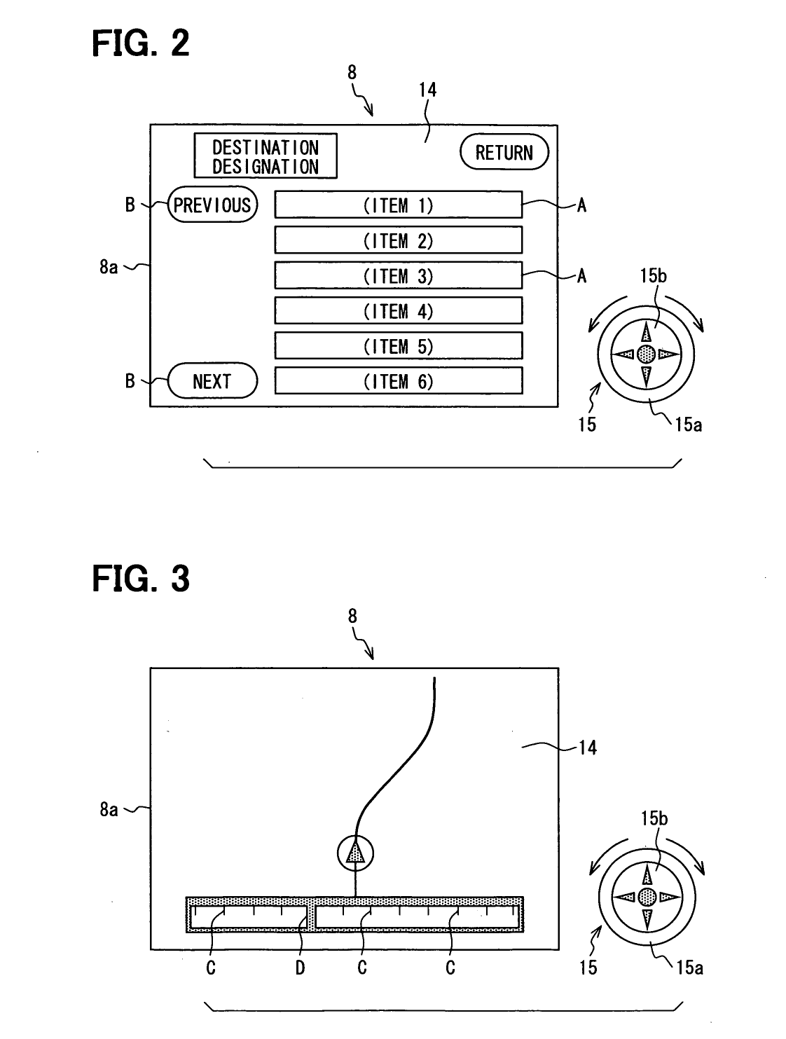

The display device 8 includes, for example, a full-color liquid crystal display, and is disposed in a center of an instrument panel in a vehicle cabin, for example. A screen 8a (see FIG. 2, FIG. 3) of the display device 8 has a display (picture) that is controlled by the control circuit 2 via a display control circuit (not shown). The screen 8a of the display device 8 displays road maps around the present position of the vehicle by various scale factors, and superimposes a present position mark on the map in a normal operation. Here, the present position mark indicates the present position and the travel direction of the vehicle. When a route guidance to the destination is executed, the display device 8 displays a picture for a route guidance.

The screen 8a of the display device 8 displays a selection picture (see FIG. 2, FIG. 3) and various messages. Here, the selection picture is used for various instruction inputs and settings (selections), such as destinations designation by the user, change of the scale factor of the displayed road map. The selection picture will be specifically described later.

The map database 6 includes a map data storage medium and a drive device. The map data storage medium stores, for example, various data sets, such as road map data of all Japan, associated destination data (facility data), and the drive device retrieves the stored data. The map data storage medium employs a mass storage medium, such as a DVD, a CD-ROM, a hard disk. The road map data includes various data sets, such as road shapes, road widths, road names, traffic signals, highway-railway crossings, buildings, various facilities, place names, geography.

Also, the road map data includes data used for reproducing the road map in the screen 8a of the display device 8. In this case, the road map data includes data used for displaying the road maps of multiple levels (for example, 12 levels) of the scale factor in the screen 8a of the display device 8. The road maps of multiple levels of the scale factors include, for example, a regional map having the scale factor of 1/50000, and a detailed map having the scale factor of 1/1000.

The destination data includes various information sets related to transportations (e.g., stations, airports), facilities (e.g., leisure facilities, accommodations, public facilities), various shops (e.g., retail stores, department stores, restaurants), housings, condominiums, and place names. The destination data includes data sets of the telephone number, address, latitude and longitude of the above destination, and the destination data also includes data for superimposing a mark indicating the facility on the road map in the screen 8a of the display device 8.

In the present case, each destination data can be specified in multiple categories, such as leisure facility, convenience store, gasoline station, restaurant, bank (bank machine service), region (e.g., states, prefectures, counties) in order to achieve a destination search function. The map database 6 stores display data of the selection picture displayed in the screen 8a of the display device 8 when the destination search is executed. The selection picture includes multiple selection items, and has a hierarchical structure, for example.

The control circuit 2 has a software structure (executes programs) to achieve (a) a location function for detecting the present position of the vehicle (the own vehicle position) and (b) a route search/guidance function for searching for a route to the designated destination and for providing a guidance to the destination. The control circuit 2 also achieves a destination search function, for example, for searching for the facility of the specified category, and for reporting the user of the facility.

The location function causes the screen 8a of the display device 8 to display the road map based on the map data from the map database 6 as above, and at the same time, the location function causes the screen 8a of the display device 8 to display the present position mark indicating the present position and the travel direction of the vehicle based on the detection by the position detector 3. In this case, the indication of the present position moves on the map with the travel of the vehicle, and the map is scrolled in accordance with the position of the vehicle. At this time, map matching is performed for adjusting the present position of the vehicle to be positioned on the road.

Also, the route search/guidance function automatically compute a recommended travel route (route) from the start point of the vehicle (present position) to the designated destination by, for example, well-known Dijkstra method, and the route search/guidance function guides the vehicle along the computed route to the destination. In the route guidance, the present position of the vehicle (present position mark) and the highlighted route to travel along are superimposed on the road map in the screen 8a of the display device 8 (see FIG. 3). Along with this, the audio output device 9 performs guidance.

As shown in FIG. 2 and FIG. 3, the input operation portion 7 includes a touch sensitive panel 14 and a hard key (hardware switch) 15 as input operation means. The touch sensitive panel 14 may be indicated as a touch sensitive screen or a touch switch in another example. The user (driver) operates the touch sensitive panel 14 and the hard key 15 to perform various instructions, inputs, settings, and selections. In other words, the user performs a touch operation to the touch sensitive panel 14 and a switch operation to the hard key 15 to perform various instructions, inputs, settings, and selections. Note that, in FIG. 2 and FIG. 3, the touch sensitive panel 14 and the hard key 15 are arranged side by side relative to each other for convenience.

The touch sensitive panel 14 is provided to a surface portion of the screen 8a of the display device 8. As well known, the touch sensitive panel 14 is a resistive touch sensitive panel made of, for example, transparent electrodes arranged transversely and longitudinally (in X, Y directions). The touch sensitive panel 14 uses a position detection circuit (not shown) to detect a position (e.g., a position defined in X, Y axes, or X, Y coordinates), which is pressed in the screen 8a, and the detection signal is inputted into the control circuit 2.

As illustrated later, the selection picture that includes multiple selection items (character keys and icons) arranged in the picture is displayed in the screen 8a of the display device 8. In the above state, the user (driver) directly touches or presses (performs a touch operation to) a position (portion) in the touch sensitive panel 14 corresponding to a selection item (key) to perform various input operations, such as destination designation (facility search), the change of the scale factor, by which the road map is displayed.

The hard key 15 is not illustrated in detail. However, in the present embodiment, the hard key 15 is a complex switch made of a rotary switch, an octal switch, and a push button switch. The hard key 15 includes a rotatable control knob 15a and a controller 15b as shown in FIGS. 2, 3. The rotatable control knob 15a is a circular rotatable controller that is provided at an outer periphery of the hard key 15. The controller 15b has a circular plate provided at an inner peripheral side of the rotatable control knob 15a. The user (driver) can rotate the rotatable control knob 15a clockwise and counter-clockwise. Also, the user can tilt the outer peripheral portion of the controller 15b in eight directions and can push (press) the entire controller 15b (e.g., a central portion of the controller 15b).

Although not fully illustrated, in the present embodiment, the hard key 15 is located at a position that allows the driver to operate the hard key 15 using a left hand in a vehicle with a right-hand steering wheel, facilitating the driver to manipulate the hard key 15 at hand without stretching the arm. Typically, the hard key 15 may be located at an inner side of the driver's seat (e.g., a right side of the driver's seat of a vehicle with a left-hand steering wheel for the operation by a right hand of the driver), or be located between a gear shift lever and a console box, for example. In this way, the hard key 15 serves as a remote operation apparatus. The control circuit 2 receives operation signals in accordance with the operation of the hard key 15. Here, the operation signals may indicate a rotation direction and a rotation amount of the rotatable control knob 15a, also, the operation signals may indicate any of eight directions of the controller 15b or press operation signals of the controller 15b. In this way, the user (driver) can more efficiently select one of the selection items in the selection picture through the operation of the hard key 15 in a state, where the screen 8a of the display device 8 displays the selection picture.

The control circuit 2 has a software structure (executes a navigation program) to display a road map screen in the normal operation. Then, in response to operation of the touch sensitive panel 14 or the hard key 15 by the user, the screen 8a of the display device 8 is caused to display the selection picture. In the selection picture, multiple selection items are arranged and displayed. In a state, where the display device 8 displays the selection picture, when the user operates the touch sensitive panel 14 or the hard key 15 to select one of the selection items, the control circuit 2 further executes a process in response to the selected one (e.g., selection-confirmed item) of the items.

In this case, as shown in the later description of the advantages, in a case, where the touch sensitive panel 14 is operated, the portion in the touch sensitive panel 14 that corresponds to the selection item is directly touched and the selection of the item is confirmed. In contrast, in another case, where the hard key 15 (typically, the rotatable control knob 15a) is operated, each item of the multiple selection items is sequentially selected (for example, the view of the selected item is made by a reverse video). If the controller 15b is pressed under the above condition, the selection of the selected selection item is confirmed. As discussed above, when the user operates the hard key 15, each item of the multiple selection items is sequentially selected. As a result, the adjustment of the operational amount of the hard key 15 (e.g., an operation number of times, an operation time, an operation distance, an operation direction) can select any one of the selection items.

Also, in the present embodiment, in a case, where the number of selection items exceeds a maximum number of selection items that can be displayed in the screen of the display device 8 within one page (e.g., in a case, where the selection items are displayed in two or more pages in the screen), a page scroll icon is displayed in the selection picture for scrolling the selection items by one page. When a portion in the touch sensitive panel 14 corresponding to the page scroll icon is touched, the selection items are scrolled in the selection picture by one page, and when the hard key 15 (the rotatable control knob 15a) is operated, the selection items are scrolled by one item.

Next, the operation of the above configuration is described with reference to FIG. 2 and FIG. 3 as an example. FIG. 2 shows a list display picture of the display device 8, in which picture, for example, possible destinations (e.g., place names, facility names) are listed as selection items. Here, if the user instructs the execution of the destination search, the control circuit 2 causes the display device 8 to display a selection picture including the multiple selection items (e.g., multiple categories, such as facility) such that the user can select one category to be searched from the multiple categories. The control circuit 2 searches (extracts) for a desired destination in the category selected by the user. The control circuit 2 causes the display device 8 to display a list of the searched possible destinations as next selection items in another selection picture (list display picture) to be displayed next.

FIG. 2 shows an example of the list display picture in the above case. For example, six selection items A (“item 1” to “item 6”) are vertically arranged in six rows and displayed in the screen 8a. Also, because selection items A of more than six items exist (i.e., the selection items A cover multiple pages) in the present case, page scroll icons B (“next” and “previous”) are displayed together with the selection items A in the screen 8a. The operation by the user (driver) of either one of the touch sensitive panel 14 and the hard key 15 can select any selection item A as the destination.

When the user performs the selection using the touch sensitive panel 14, any one of the six selection items A (“item 1” to “item 6”) listed in the screen can be directly touched, and the touch operation can confirm the selection of the touched selection item A. If the item that the user wishes to select does not exist in the screen (i.e., in the six selection items displayed in the screen), the user can touch the page scroll icon B to scroll the selection items A by one page, and the listed items of the next page (for example, “item 7” to “item 12”) are displayed, which are not shown. The page can also be returned to the previous page.

In contrast, in another case, where the user performs the selection using the hard key 15, when the user slightly rotates the rotatable control knob 15a, for example, the first selection item A (“item 1”) is selected (displayed as reverse video) firstly. In the above state, when the user rotates the rotatable control knob 15a clockwise, each of other selection items are sequentially selected (displayed as reverse video) in an order from “item 1”, to “item 2”, and “item 3” by one item (row) (downwardly in FIG. 2) in accordance with the rotation angle. When the user rotates the rotatable control knob 15a counter-clockwise, each of the selection items is sequentially selected (displayed as reverse video) in an opposite order opposite the above in the screen (upwardly in FIG. 2).

For example, when the user further rotates the rotatable control knob 15a clockwise in a state, where the selection item A (“item 6”) that is located in the lowest in the row is selected, the selection item A is scrolled by one item. In other words, when the selection item A is scrolled by one item from a state shown in FIG. 2, “item 2” to “item 6” are moved in respective upper rows by one row, and “item 7” is displayed at the sixth row (the above is not shown). In this case, if the rotatable control knob 15a is rotated quickly, a movement speed (scroll speed) of the selected item (item displayed as reverse video) is also increased.

In this way, when the user press the controller 15b in a state, where the desired selection item A (destination) is selected (displayed as reverse video), the selection of the desired selection item A is confirmed. Note that, after this, the control circuit 2 computes the recommended travel route (route) from the present position of the vehicle to the confirmed destination and executes the route guidance to the confirmed destination.

FIG. 3 shows an example of a map scale setting picture having multiple kinds of selectable scale factors as the selection items in the screen of the display device 8 while the road map is displayed. The road map in the map scale setting picture fully extends almost to the end of the screen 8a of the display device 8 except a lower end portion, and the multiple kinds (for example, 12 kinds) of scale factors are arranged transversely and displayed as selection items C at the lower end portion of the screen 8a. In the present embodiment, the entire of the selection items C has a ruler-like shape, and scale marks C of 12 levels are displayed as the selection items to indicate the scale factors of the map.

For example, the first scale mark C from the left corresponds to the most detailed map having a scale factor of, for example, 1/1000, and the scale factor gradually becomes larger when the position in the ruler goes rightward to correspond to the regional map. Although not illustrated, the scale factor is displayed along with the scale mark C. A pointer D is provided to point any one of the scale marks C to indicate the scale factor of the presently displayed map. In FIG. 3, the fifth scale factor from the left is presently selected. The user (driver) can select (change) the scale factor (scale mark C) of the displayed map through the operation of either one of the touch sensitive panel 14 and the hard key 15.

When the user selects (changes) the scale factor using the touch sensitive panel 14, the user can perform the touch operation directly to one of the 12 scale marks C (in practice, 11 scale marks except the presently selected scale mark) in the screen, and the touch operation confirms the selection of the scale factor. In this case, the control circuit 2 moves the pointer D to the selected scale factor (scale mark C) and the map having the selected scale factor is displayed.

In contrast, in a case, where the user performs the selection using the hard key 15, when the user rotates the rotatable control knob 15a clockwise, the pointer D moves rightward by one level of the scale mark C from the present position toward the position corresponding to the regional map. When the user rotates the rotatable control knob 15a counter-clockwise, the pointer D moves leftward by one level of the scale mark C from the present position toward the position corresponding to the detailed map. The user stops operating the hard key 15 when the pointer D is positioned at a scale mark C indicting the desired scale factor, and thereby the desired scale factor is confirmed. Then, the control circuit 2 changes the display of the map into the map of the selected scale factor.

Note that, in the map scale setting picture, if the number of kinds of the selectable scale factor is more than that in the present embodiment, only a part of the selectable scale factors are displayed in one screen, and the rest of the selectable scale factors can be scrolled transversely to be displayed in the screen. In the above case, the operation using the touch sensitive panel 14 scrolls the selectable scale factors by one page, and the operation of the hard key 15 scrolls the selectable scales by one item.

As above, according to the present embodiment, the operation of the either one of the touch sensitive panel 14 and the hard key 15 enables the selection of the selection item both in the list display picture (FIG. 2) and in the map scale setting picture (FIG. 3). As discussed above, the user selects and confirms the destination in the list display picture (FIG. 2), and the user sets the scale factor of the displayed map in the map scale setting picture (FIG. 3). The user can directly touch any position in the screen 8a when the user uses the touch sensitive panel 14. In other words, the user can performs the touch operation directly to any position in the screen 8a by using the touch sensitive panel 14. As a result, the touch sensitive panel 14 is preferable to a discontinuous operation, in which one item in the midway position is omitted and another item in the target position is directly selected. Also, the hard key 15 is preferable to a continuous operation (e.g., keep pressing, keep rotating) that last for a certain period. Thus, the above characteristics (advantages) in the operations of the touch sensitive panel 14 and the hard key 15 are considered, and the selection operation can be performed in accordance with the characteristics in the present embodiment.

In other words, even when multiple selection items are arranged in the selection picture, and each indicates the change by one level relative to each other, one selection item that is positioned away from another selection item can be selected by bypassing all the selection items positioned between the one and the another. The above typical discontinuous operation can be easily done by the operation through the touch sensitive panel 14. However, because the touch sensitive panel 14 may not accurately detect the press by the user, for example, the touch sensitive panel 14 may not be suitable for a continuous operation, in which the touch sensitive panel 14 is kept pressed for a certain period of time.

In contrast, the hard key 15 may not be suitable for the discontinuous operation. However, the user can feel a sense of the operation of the hard key 15, and thereby the user can easily tell that the user actually operates the hard key 15. Thus, the hard key 15 is suitable for the continuous operation, in which the hard key 15 is kept pressed or rotated for a certain period. In the present embodiment, the above characteristics of the touch sensitive panel 14 and the hard key 15 care considered to facilitate the operation by the user.

As a result, the selection item is selectable even when the user operates either one of the touch sensitive panel 14 and the hard key 15. Also, at the same time, because a process of confirming the selection is different depending on the use of either one of the touch sensitive panel 14 and the hard key 15, either one of the touch sensitive panel 14 and the hard key 15 has its own function different from the other. Thus, compared with a case, where each of the touch sensitive panel 14 and the hard key 15 has a function equivalent to each other, the present embodiment can provide more improved operability to the user.

Specially in the present embodiment, in the above list display picture, the page scroll icons B are provided for scroll the selection items A by one page, and when a portion in the touch sensitive panel 14 corresponding to the page scroll icon B is touched, the selection items A are scrolled by one page, and when the user operates the hard key 15, the selection items A are scrolled by one row. Therefore, the user can perform operations taking advantage of the characteristics of each of the touch sensitive panel 14 and the hard key 15. Thus, the list display picture does not require items (icons) for scrolling the selection items A by one item (i.e., scroll by one row) in the operation through the touch sensitive panel 14, and thereby the list display picture can advantageously have a simple display.

Further, in the present embodiment, because the hard key 15 has the rotatable control knob 15a that can be rotated by the user, the operability of the hard key 15 by the user can be further improved. Also, the hard key 15 serves as the remote operation apparatus that is provided in a vicinity of the driver's seat, the operability of the hard key 15 by the driver can be advantageously improved.

Note that, the present invention is not limited to the above described embodiments. However, the present invention can be modified or extended as described below. In other words, in the above embodiment, the designation of the destination (selection of the destination from a search list) and the change of the map scale factor are described. However, the present invention can be alternatively applied to various searches and settings in a navigation system. Also, the present invention is not limited to the navigation system, but the present invention can be alternatively applied to an operation apparatus for an on-vehicle device in general, such as for volume adjustment, for track selection of CD, for channel selection (station selection) in TV and radio broadcastings for a vehicle audio device, or for a target temperature setting for a vehicle air conditioning apparatus.

Also, in the embodiment, the hard key 15 is a complex switch that is made of the rotatable control knob 15a and the controller 15b. However, the hard key 15 may employ a slide switch that is operated through a sliding motion of the operation knob, or employ a ball-shaped controller (haptic device) that enables rotation operation in any directions. In the above case, multiple switches may be combined.

Furthermore, when the hard key serves as the remote operation apparatus, the hard key may be provided, for example, in the vicinity of the meters in the instrument panel, or in a part of the steering wheel in place of the vicinity of the gear shift lever. Also, the remote operation apparatus may further be configured to operate other on-vehicle devices (e.g., an electrically-driven door mirror or side mirror, a power window, a wiper, a turn signal, a lamp). Also, for example, the display condition (screen configuration) of the selection item can be modified in various manners. The present invention can be modified as necessary provided that the gist is not deviated.

Additional advantages and modifications will readily occur to those skilled in the art. The invention in its broader terms is therefore not limited to the specific details, representative apparatus, and illustrative examples shown and described.

What is claimed is:

1. An operation apparatus for an on-vehicle device mounted on a vehicle, wherein the apparatus is used for performing various instructions and settings of the on-vehicle device, the apparatus comprising:
a display device that is configured to display a selection picture, in which a plurality of selection items are arranged;
a touch sensitive panel that is disposed on a screen of the display device, the touch sensitive panel enabling one of the plurality of selection items in the selection picture to be selected by a touch operation of a user;
a hard key that enables one of the plurality of selection items in the selection picture to be selected by a switch operation of the user; and
a control device that is configured to scroll the plurality of selection items in the selection picture in accordance with a user operation, wherein:
the control device scrolls the plurality of selection items in the selection picture by a first amount when the user operation is the touch operation by the user to the touch sensitive panel; and
the control device scrolls the plurality of selection items in the selection picture by a second amount when the user operation is the switch operation by the user to the hard key, the first amount being different from the second amount.

2. The operation apparatus according to claim 1, wherein:
the selection picture has a page scroll icon for scrolling the plurality of selection items by one page when a number of the plurality of selection items exceeds a maximum number of selection items displayed in the screen of the display device;
when a portion in the touch sensitive panel that corresponds to the page scroll icon is touched, the plurality of selection items is scrolled by one page in the selection picture; and
when the hard key is operated, the plurality of selection items is scrolled by one item.

3. The operation apparatus according to claim 1, wherein:
the hard key includes a rotatable controller that is rotatable by the user.

4. The operation apparatus according to claim 1, wherein:
the hard key is provided in a vicinity of a driver seat and is configured to be remotely operated by a driver of the vehicle.

5. The operation apparatus according to claim 1, wherein:
the operation apparatus serves as an apparatus for input operation to a navigation system.

6. The operation apparatus according to claim 5, wherein:
the selection picture serves as a list display picture that lists place names or facilities as the plurality of selection items.

7. The operation apparatus according to claim 5, wherein:
the selection picture serves as a map scale setting picture that displays a plurality of scale factors as the plurality of selection items, a road map being displayed in the display device by each of the plurality of scale factors.

8. The operation apparatus according to claim 1, wherein:
the first amount corresponds to one page and the second amount corresponds to one item.

9. An operation apparatus for controlling a picture in a screen of a display device, the apparatus comprising:
a touch sensitive panel that is configured to output a first signal when the touch sensitive panel is touched;
a hard key that is configured to output a second signal when the hard key is operated; and
a control device that is configured to scroll the picture in the screen upon receiving one of the first and second signals, wherein:
the control device scrolls the picture by a first amount when the control device receives the first signal; and
the control device scrolls the picture by a second amount when the control device receives the second signal, the second amount being different from the first amount.

10. The operation apparatus according to claim 9, wherein:
the picture includes a plurality of selection items; and
the second amount corresponds to a size of one of the plurality of selection items.

11. The operation apparatus according to claim 9, wherein:
the first amount corresponds to one page, which is a maximum size that is displayed in the picture in the screen.

12. The operation apparatus according to claim 9, wherein:
the hard key includes a rotatable controller that is rotatable by a user.

13. The operation apparatus according to claim 9, wherein:
the second amount is smaller than the first amount.

14. The operation apparatus according to claim 9, wherein:
the display device is used in a vehicle navigation system.
